(19) United States
(12) Patent Application Publication
(10) Pub. No.: US 2012/0073073 A1
(43) Pub. Date: Mar. 29, 2012

(54) PAINT PAD DEVICE

(76) Inventors: Matthew Scott Graham, Noblesville, IN (US); Brian Belcher, Brownsburg, IN (US); Louis B. Schiesz, Fishers, IN (US)

(21) Appl. No.: 13/099,109

(22) Filed: May 2, 2011

Related U.S. Application Data
(60) Provisional application No. 61/330,368, filed on May 2, 2010.

(51) Int. Cl. B05C 17/00

(52) U.S. Cl. 15/209.1

(57) ABSTRACT

A painting device is disclosed in one embodiment having a paint pad and an assembly useful in coupling to and manipulating the paint pad during use. The painting device can include jaws that are moveable relative to each other to couple to the paint pad. A guard member can be provided to protect a periphery of the paint pad. The guard member can be moved relative to the paint pad to selectively expose the periphery of the paint pad. A coupling member capable of being coupled to another device and/or directly used to manipulate the painting device can be moved relative to the paint pad. The coupling member can be rotated to different positions using a selector that permits such rotations.

### CROSS-REFERENCE TO RELATED APPLICATIONS

This application claims the benefit of U.S. Provisional Application No. 61/330,368, filed May 2, 2010, which is incorporated herein by reference in its entirety.

### TECHNICAL FIELD

The present invention generally relates to painting devices, and more particularly, but not exclusively, to paint pad devices.

### BACKGROUND

Providing painting devices having a variety of adjustable and/or protective features remains an area of interest. Some existing systems have various shortcomings relative to certain applications. Accordingly, there remains a need for further contributions in this area of technology.

### BRIEF DESCRIPTION OF THE DRAWINGS

FIG. 1 is a perspective view illustrating a painting device according to one embodiment.

FIG. 2 is a perspective view illustrating the painting device shown in FIG. 1, in which a guard member is at an intermediate position.

FIG. 3 is a perspective view illustrating the painting device shown in FIG. 1, in which a guard member is at another position.

FIG. 4 is a side elevation view of the painting device as shown in FIG. 3.

FIG. 5 is a side elevation view of the painting device as shown in FIG. 1.

FIG. 6 is a perspective view illustrating the painting device shown in FIG. 1 from another angle.

FIG. 7 is an exploded perspective view of the painting device as shown in FIG. 6.

FIG. 8 is a side elevation view illustrating one embodiment of a painting device having a coupling member at a position.

FIG. 9 is a side elevation view illustrating another embodiment of a painting device having a coupling member at another position.

FIG. 10 is a top elevation view illustrating one embodiment of a painting device having jaws at a position.

FIG. 11 is a top elevation view illustrating another embodiment of a painting device having jaws at another position.

FIG. 12 is a front elevation view illustrating one embodiment of a painting device having a selector at a position.

FIG. 13 is a front elevation view illustrating another embodiment of a painting device having a selector at another position.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

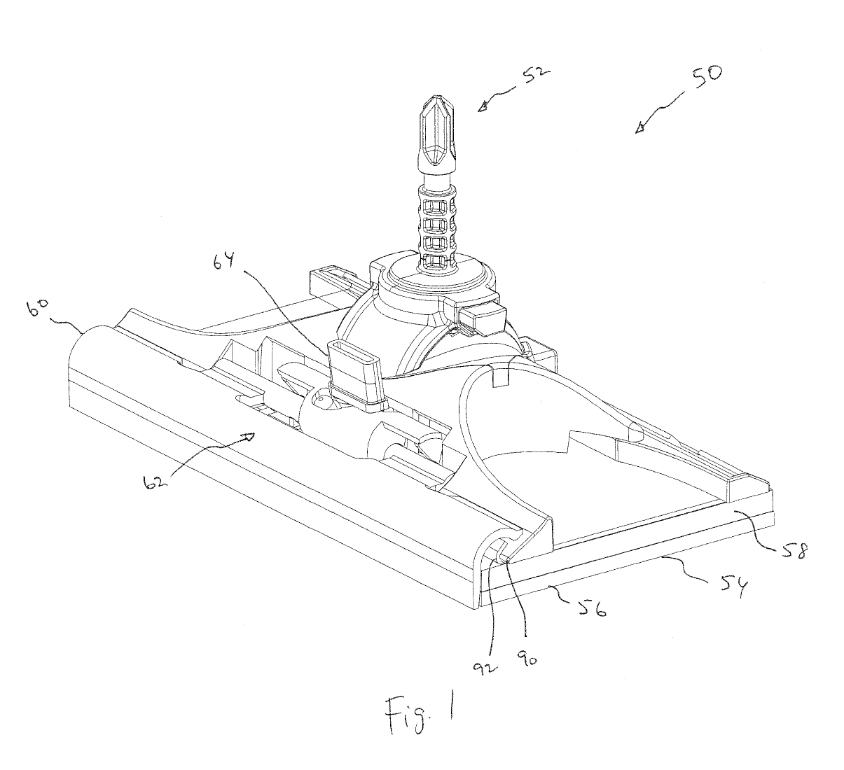

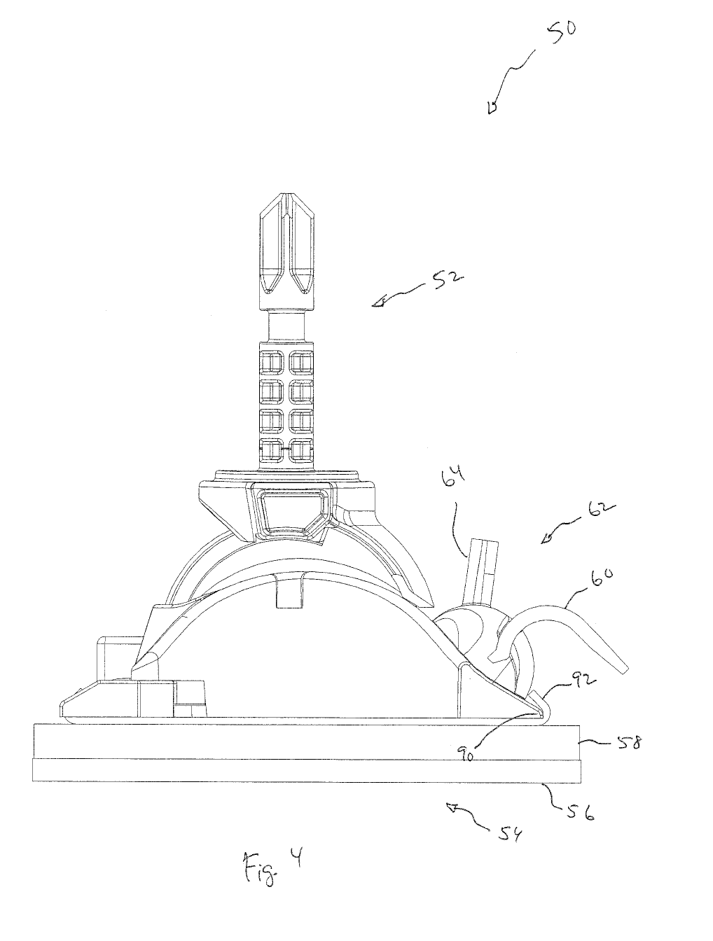

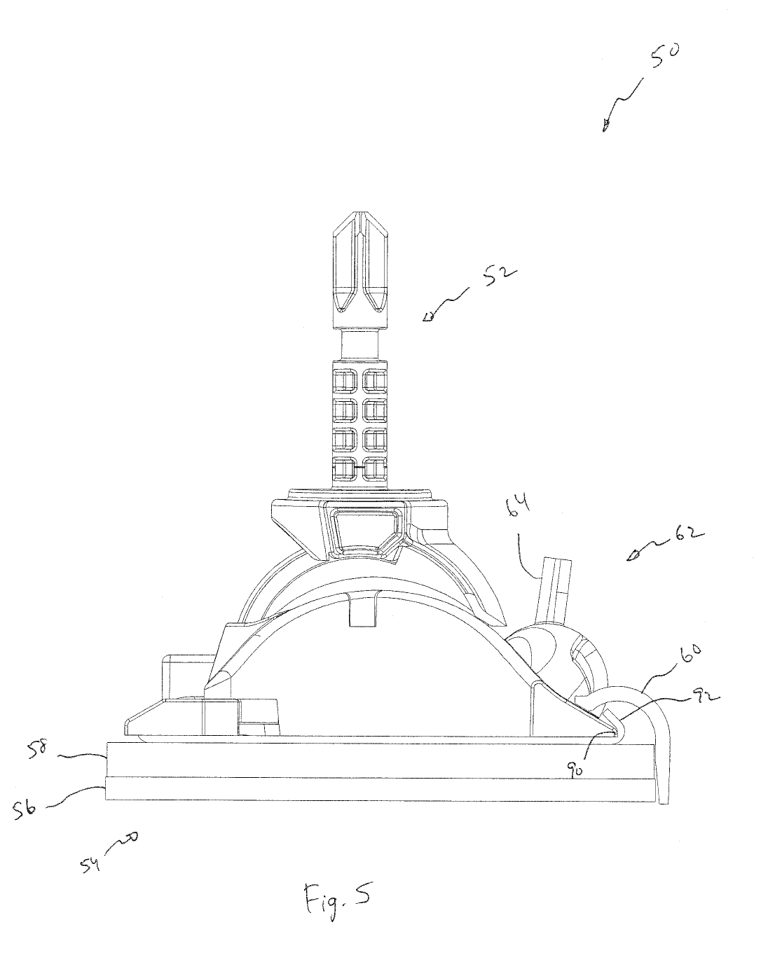

With reference to FIGS. 1-5, a device 50 is disclosed that can be used to apply a substance, such as but not limited to paint, to an application surface that can include any variety of surfaces suitable to receive the substance. The substance can take a variety of forms such as liquids or pasty substances, among potential others, and can have a variety of consistencies or compositions. The substance can be applied in a layer. In some forms the application surface can include drywall, doors, trim, cabinets, and window frames to set forth just a few non-limiting embodiments. The application surface can include any variety of materials such as drywall, wood, and engineered substances, among potential others.

For ease of discussion and for purposes of explanation, the description herein will refer to the device 50 as a painting device 50 and the substance that the device 50 applies to the application surface as paint, but it will be appreciated that the device 50 can be used to apply substances other than paint in many different embodiments.

The painting device 50 applies paint with a paint applicator 54 that in the illustrative embodiment is the form of a pad. The paint applicator 54 can have a variety of textures, sizes, and shapes. Furthermore, the paint applicator 54 can be made of a variety of textures. In some embodiments the paint applicator 54 can be cleaned by a solvent or other substance that removes the paint from the pad. The paint applicator 54 can have a relatively pliable paint applicator surface 56 and a relatively firm backing 58 used to provide rigidity to the pad and to permit the applicator 54 to be selectively coupled with a device such as a removable handle, or the painting device 50. The backing 58 can be composed of any number of components releasably or permanently attached to each other, and can also be a unitary body in some embodiments. Other configurations are contemplated herein.

The painting device 50 includes a coupling member 52 that can be used to couple the painting device 50 to a handle (not shown) or other structure that permits the painting device 50 to be manipulated into a variety of positions or motions. The coupling member 52 can sometimes be referred to as a dart and can take a variety of sizes and shapes. In some embodiments of the painting device 50 the coupling member 52 can itself take the form of a handle or other structure and is not otherwise coupled to anything else.

The painting device 50 can include a guard member 60 used to cover an outer periphery of the paint applicator 54. In one form the guard member 60 covers one edge of a quadrilateral shaped paint applicator 54. The guard member 60 can be used to cover all or a portion of an outer periphery of the paint applicator 54. For example, the guard member 60 can extend toward the bottom portion of the paint applicator 54 and may even extend past in some embodiments. In other embodiments the guard member 60 can only extend such that a portion of the bottom part of the paint applicator 54 is exposed. The guard member 60 can be arranged to selectively cover the paint applicator 54. In one form the guard member 60 can be moved relative to the paint applicator 54 to selective expose an edge of the paint applicator 54. The guard member 60 can be relatively moved by rotation, translation, and a mixture of rotation and translation. In the illustrative form the guard member 60 is moved by rotation, as will be described in greater detail below.

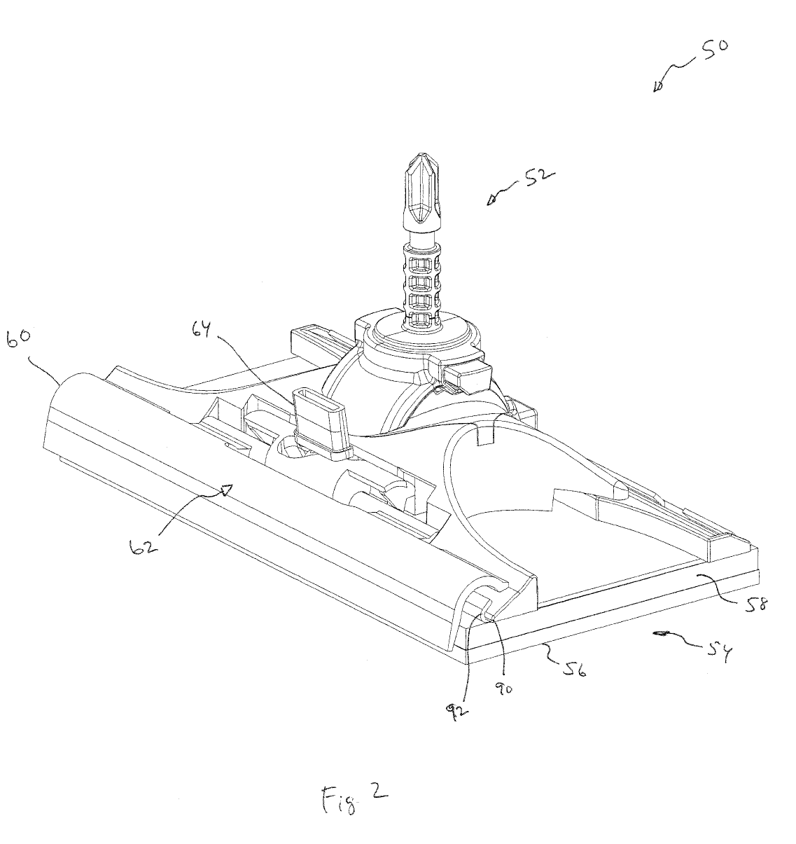

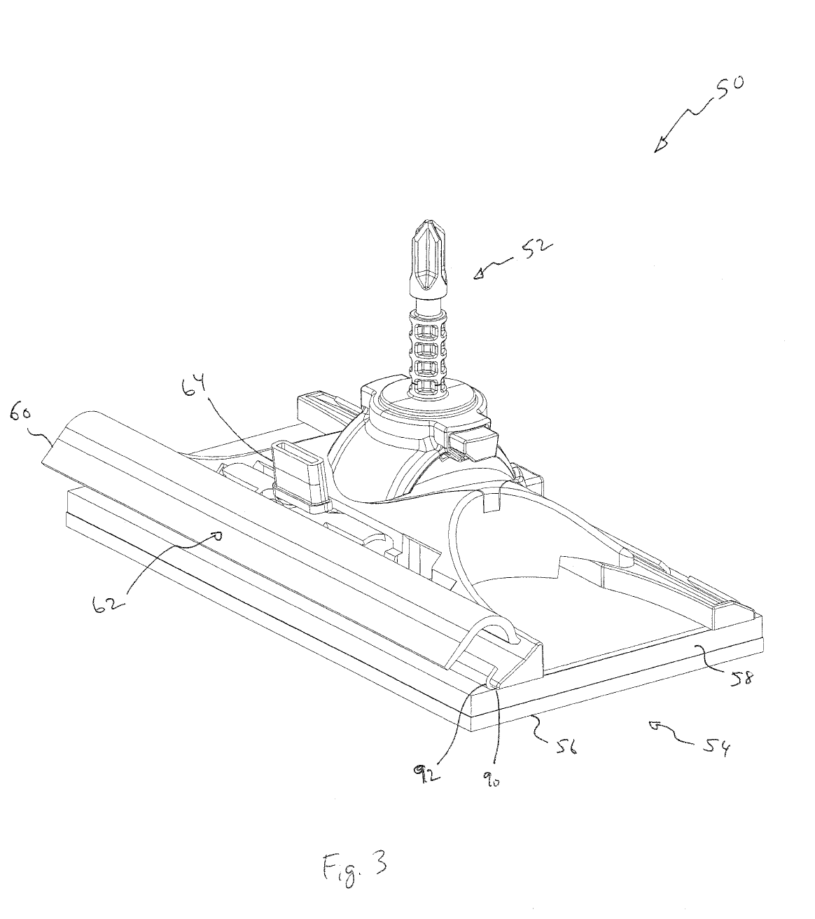

FIGS. 1-3 illustrate relative motion between the guard member 60 and the paint applicator 54 in one embodiment of the painting device 50. The guard member 60 is rotated from a covered position in FIG. 1 to an intermediate and final position in FIGS. 2 and 3, respectively. Though FIG. 3 depicts one embodiment of a final position of the guard member 60 relative to the paint applicator 54, other embodiments may have a different final position whether the final position is greater than or less than the angular rotation depicted in FIG. 3.

The guard member 60 can be moved relative to the paint applicator 54 with a guard actuator 62. In one form the guard actuator 62 includes an actuation extension 64 that can be manipulated to provide motive to the guard member 60 relative to the paint applicator 54. The actuation extension 64 is movable relative to the paint applicator 54. In some forms the actuation extension 64 need not be moved relative to the paint applicator 54 in the same manner as the guard member 60 is moved relative to the paint applicator. For example, the actuation extension 64 can be translatingly moved relative to the paint applicator 54 which causes the guard member 60 to be rotatingly moved relative to the paint applicator 54. Thus, there are many different types of relative movement that each of the guard member 60 and actuation extension 64 can provide. In some forms the actuation extension 64 can be manipulated to move relative to the paint applicator 54 by an external device such as a track assembly (not shown).

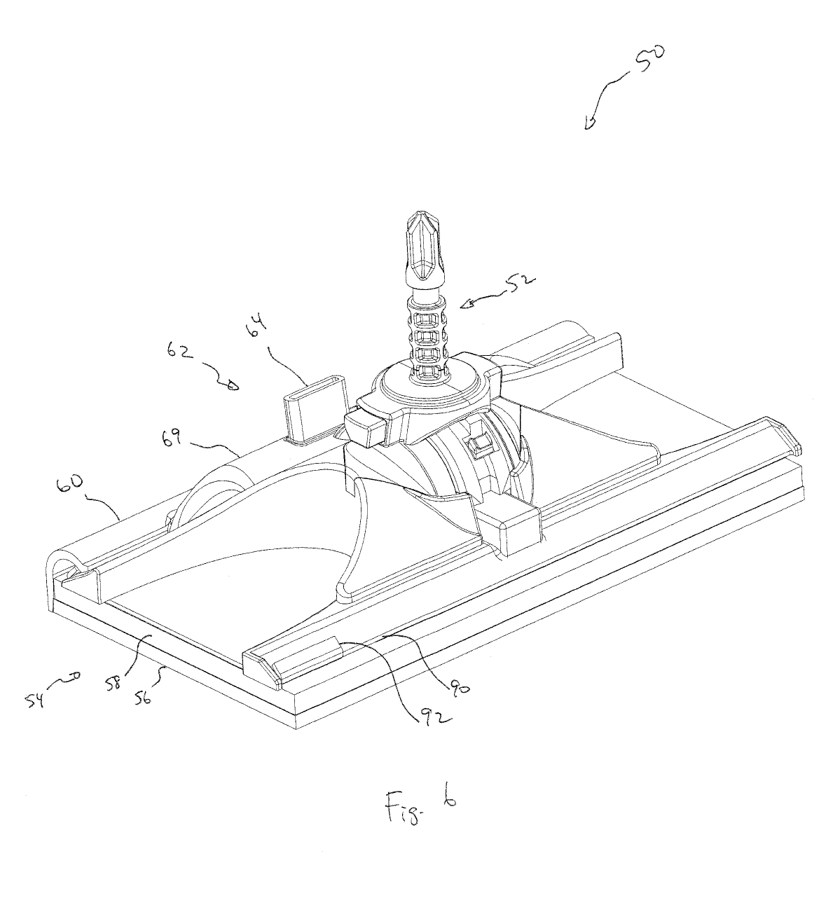

Turning now to FIG. 6, another view is shown of the painting device 50. The various features of the painting device 50 discussed above are also depicted in this figure, albeit from a different vantage point.

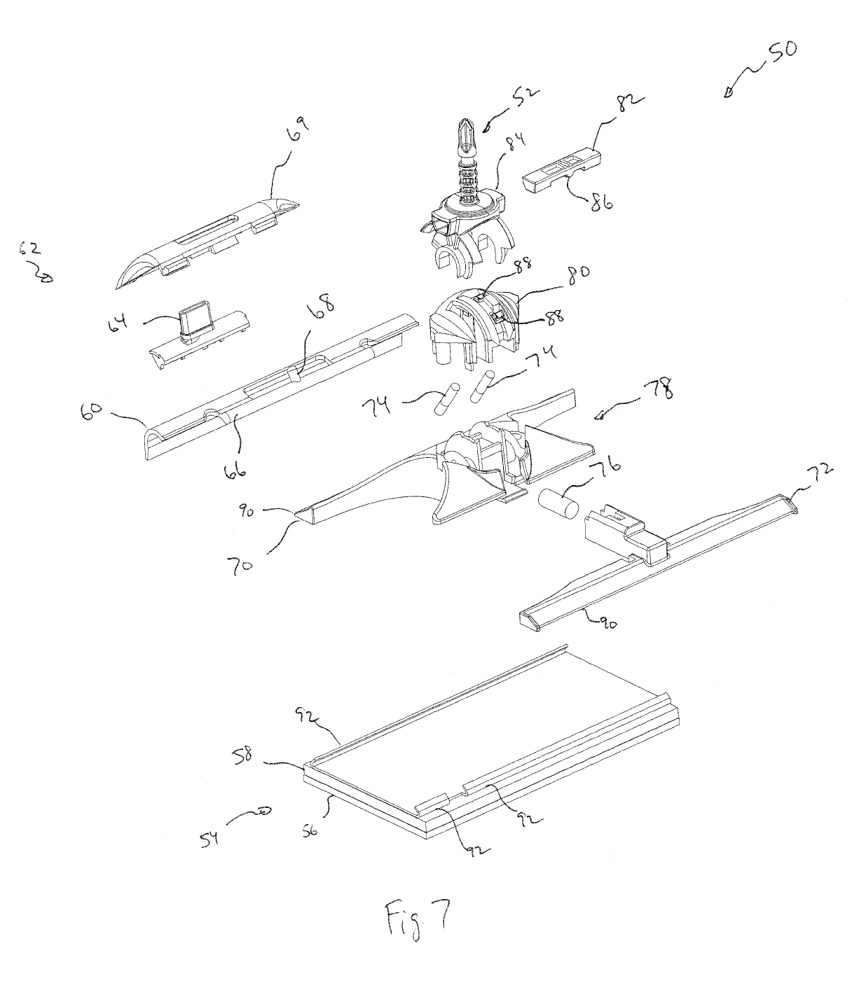

FIG. 7 depicts a view of various components of one embodiment of the painting device 50. The guard member 60 is depicted in the illustrative form including a guard extension 66 and a rib 68. In one form the rib 68 is affixed to the guard extension 66 and is used to interact with the guard actuator 62 such that when the guard actuator 62 is moved it causes movement in the rib 68, and consequently the guard extension 66.

The painting device 50 can also include a cover 69 used to shield a portion of the relatively moving parts of the guard member 60 and/or the guard actuator 62.

The painting device 50 can also include a left jaw 70 and a right jaw 72 that are capable of moving relative to each other and that are used to couple the paint applicator 54 to the painting device 50. The terms “left” and “right” are used herein for ease of description and are not meant to otherwise limit the orientation of the jaws in the painting device 50. Each of the jaws can include a jaw engaging portion 90 that is used in one embodiment to engage with pad engaging portions 92 of the paint applicator 54. The jaw engaging portions 90 can extend the entire length, or a portion of the entire length, of either or both of the left jaw 70 and right jaw 72. The jaw engaging portions 90 can have different shapes on each of the left jaw 70 and right jaw 72. The pad engaging portions 90 can also extend the entire length, or a portion of the entire length, of either or both portions of the paint applicator 54. In addition, any number of engaging portions can be used.

The left jaw 70 and the right jaw 72 can be moved relative to each other in a variety of manners whether translational, rotational, and a combination of the two. The left jaw 70 and the right jaw 72 can be biased relative to each other through the use of an energy member 76. The energy member 76 can include more than one energy member in other embodiments. In one form the energy member 76 is a coil spring, but other devices capable of generating a force when deflected can also be used. In one embodiment the left jaw 70 and the right jaw 72 are biased away from each other such that the jaws 70 and 72 must be moved toward each other so that the paint applicator 54 can be coupled to the painting device 50.

Though the left jaw 70 includes a form and components that the right jaw 72 does not, in some embodiments the jaws 70 and 72 can be symmetric pairs of a jaw assembly. The left jaw 70 in the illustrative embodiment includes a center jaw portion 78 that can be used to couple the jaws 70 and 72 to the coupling member 52. As used herein the term “center” used in the element “center jaw portion” is for ease of reference only and is not intended to indicate a geometric relation between either of the jaws 70 and 72 to the jaw portion 78. In the illustrative embodiment the center jaw portion 78 is coupled to the coupling member 52 using an intermediate component, but other forms of the center jaw portion 78 can be directly connected to the coupling member 52.

The left jaw 70 can be coupled to the coupling member 52 using the jaw coupler 80. In one embodiment the jaw coupler 80 is rotatingly coupled with the coupling member 52. A selector 82 is provided in the illustrative embodiment to permit the coupling member 52 to be oriented at different positions relative to the jaw coupler 80. The selector 82 can be inserted into aperture 84 and can be manipulated to permit the coupling member 52 to be moved. In one form the coupling member 52 can be moved using a rotating motion, but other types of motions are also contemplated herein. In one form the selector 82 can also be used as a lock to positively connect the coupling member 52 to the jaw coupler 80.

Members 74 can be used in the painting device 50 to connect any of the jaws 70 and 72, the jaw coupler 80, and the coupling member 52. In one non-limiting form the members 74 can take the form of a spring or other device capable of producing a force upon deflection. In this form the members 74 can be positioned to provide a force to the coupling member 52 if the coupling member 52 is moved relative to the paint applicator 54.

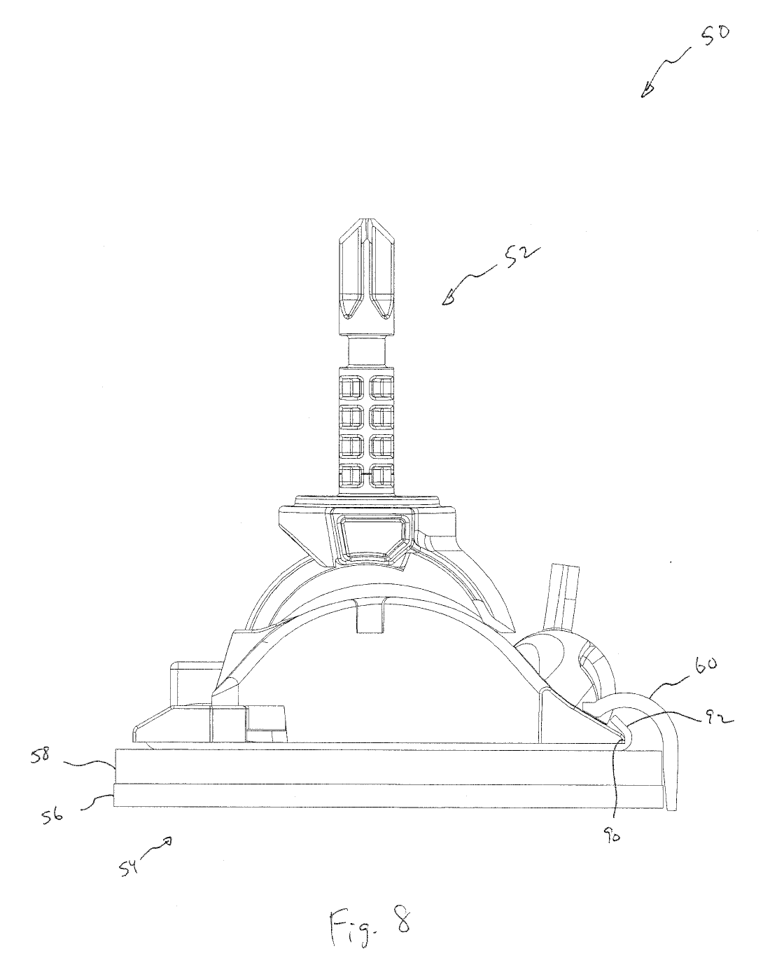

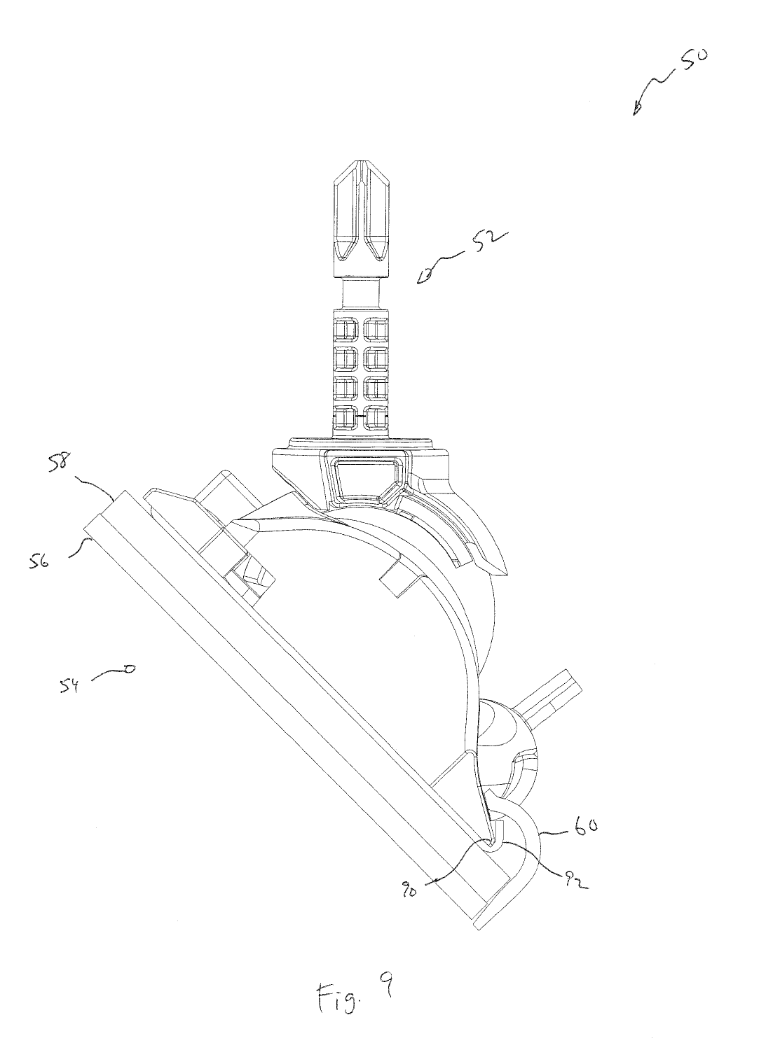

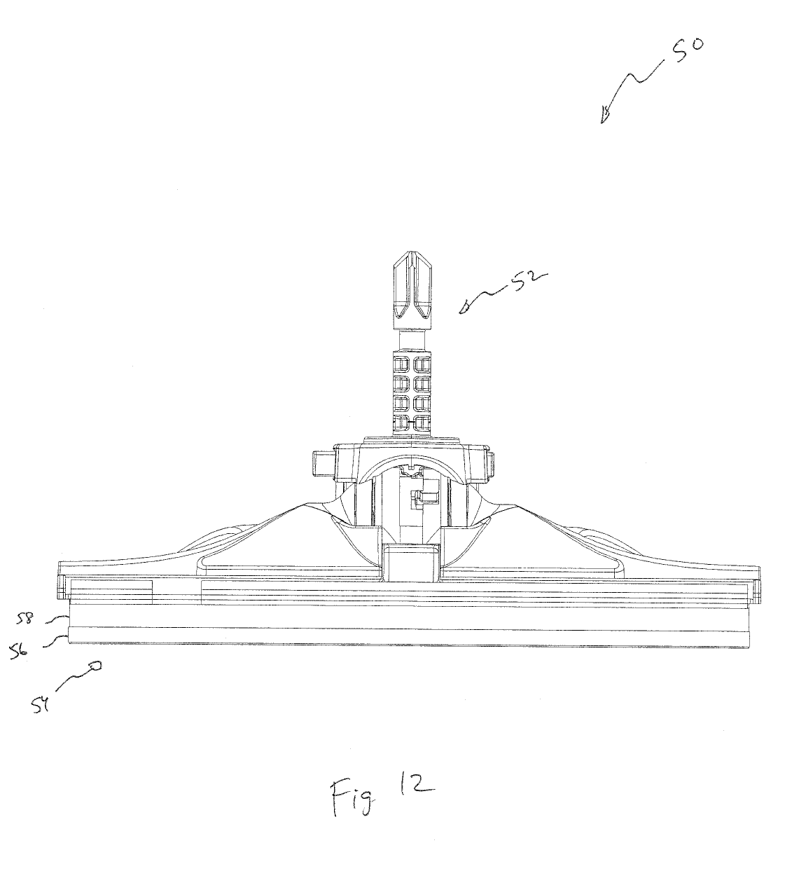

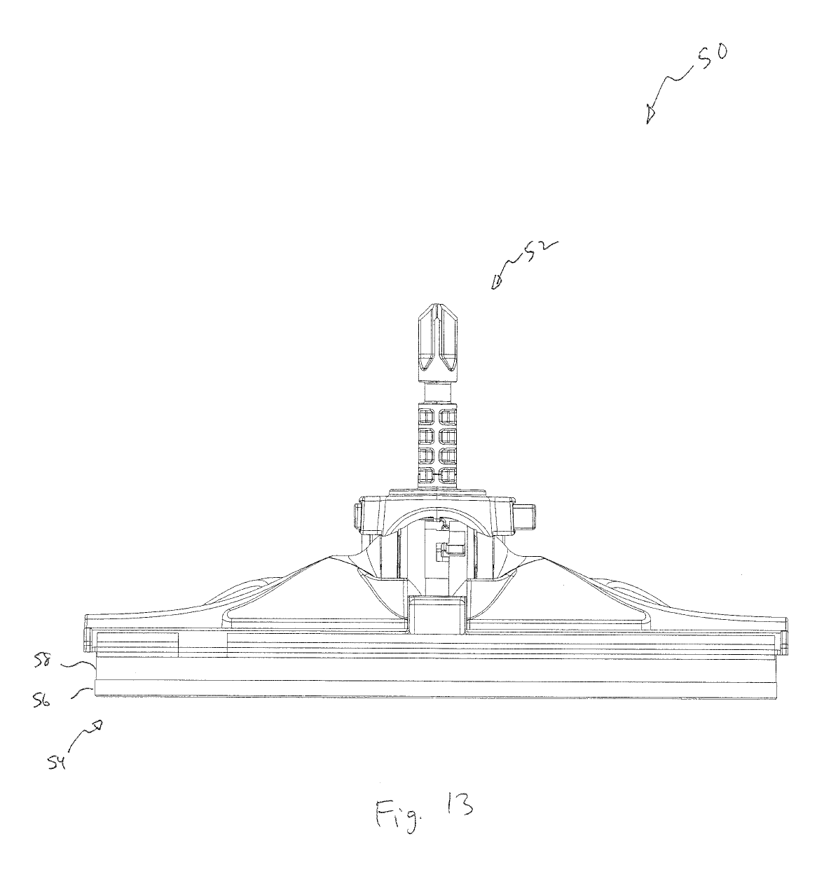

Turning now to FIGS. 8-9 and 12-13, and with continuing reference to FIG. 7, operation of the selector 82 as well as relative movement of the coupling member 52 to the paint applicator 54 is shown. FIGS. 8-9 show one embodiment in which the coupling member 52 is rotated from an upright position in FIG. 8 to an inclined position in FIG. 9. FIGS. 12-13 show movement of the selector 82 that permits rotation of the coupling member 52 to the paint applicator 54. FIG. 12 depicts the position of the selector 82 that permits movement of the coupling member 52 relative to the paint applicator 54. FIG. 13 depicts the position of the selector 82 in which relative movement of the coupling member 52 and paint applicator 54 is discouraged. In one embodiment the selector 82 includes an operative surface 86 that is capable of engaging selector receiving surfaces 88 of the jaw coupler 80. Though only two selector receiving surfaces 88 are shown in the illustrative embodiment, other embodiments can include more selector receiving surfaces. In addition, other embodiments of the painting device 50 can permit a variety of movements that are not necessarily limited to discrete positions.

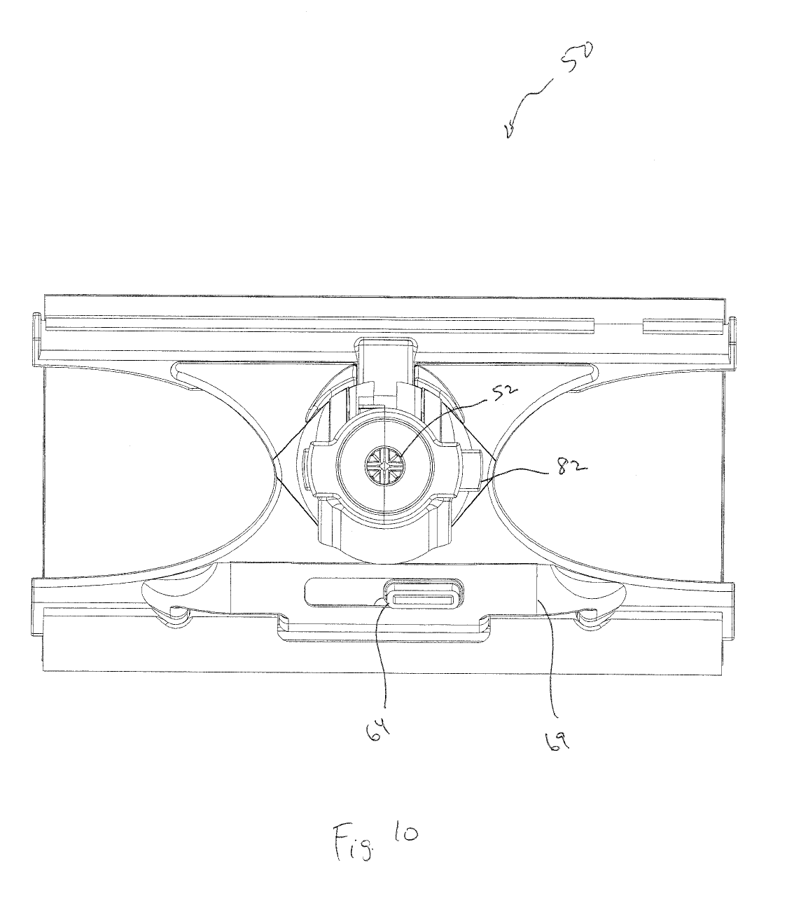

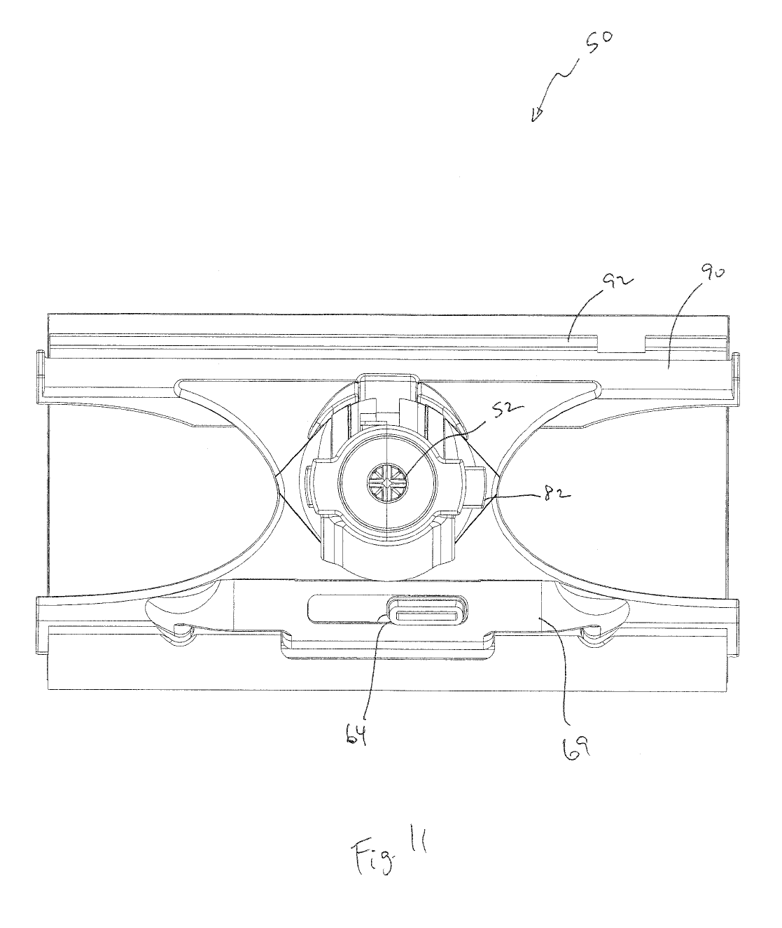

Turning now to FIGS. 10 and 11, one embodiment of the painting device 50 is shown where movement of the jaws 70 and 72 are illustrated to couple the paint applicator 54. FIG. 10 illustrates the engaged state of the jaws 70 and 72 to the paint applicator 54. FIG. 11, in contrast, shows the disengaged state of the jaws 70 and 72 to the paint applicator. In the illustrative form the jaws 70 and 72 can be disengaged when they are moved toward one another and are engaged when moved toward one another. Other embodiments, however, may contemplate other types of relative movements, whether translational, rotational, to set forth just two non-limiting possibilities.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An apparatus comprising:
a paint pad device having a paint pad portion with an edge and a moveable guard structured to selectively cover the edge.

2. The apparatus of claim 1, which further includes a moveable guard actuator structured to selectively move the moveable guard relative to the edge of the paint pad portion.

3. The apparatus of claim 2, wherein the moveable guard includes a portion intermediate ends of the moveable guard, the portion structured to engage the moveable guard actuator.

4. The apparatus of claim 3, wherein the moveable guard actuator is moved linearly and the moveable guard is rotated.

5. The apparatus of claim 1, which further includes a pair of jaws moveable relative to each other to selectively engage the paint pad portion.

6. The apparatus of claim 5, wherein the pair of jaws are spring loaded.

7. The apparatus of claim 1, wherein the paint pad device further includes a coupling extension that is operable to be rotated relative to the paint pad portion, the coupling extension structured to engage with a handle.

8. The apparatus of claim 7, which further includes a selector structured to selectively inhibit rotation of the coupling extension relative to the paint pad portion.

9. An apparatus comprising:
a painting applicator having adjustable pad coupling members movable relative to each other having portions capable of engaging a variety of paint pad sizes.

10. The apparatus of claim 9, wherein the adjustable pad coupling members are translating moveable relative to each other, the painting applicator including a biasing member that imparts a force when the adjustable pad coupling members are moved relative to each other.

11. The apparatus of claim 10, wherein the adjustable pad coupling members are moved inwardly toward one another to disengage the painting applicator from a paint pad.

12. The apparatus of claim 9, which further includes a pad guard member operable to selectively expose an edge of a paint pad when coupled to the painting applicator.

13. The apparatus of claim 12, wherein the pad guard member is rotatingly moved relative to the paint pad when a guard actuator is actuated.

14. The apparatus of claim 9, which further includes a portion extending from the painting applicator structured to selectively engage with a paint handle, the portion selectively moveable relative to the adjustable pad coupling members.

15. The apparatus of claim 14, which further includes a locking device structured to lock the portion relative to the adjustable pad coupling members.

16. The apparatus of claim 15, wherein the locking device permits discrete movements of the portion relative to the adjustable pad coupling members when the locking device is not locked.

17. An apparatus comprising:
a painting pad device having a paint pad receiving portion and having a dart configured to be releasably engagable to a painting handle, the dart operable to be relatively oriented to provide a variety of painting positions for a paint pad.

18. The apparatus of claim 17, which further includes a selecting member capable of being manipulated to permit relative movement of the painting pad device to the paint pad.

19. The apparatus of claim 18, wherein the painting pad device can be rotated relative to the painting pad device when the selecting member is manipulated to a first position.

20. The apparatus of claim 18, wherein the painting pad device can be moved to one of a discrete number of positions.

21. The apparatus of claim 17, which further includes engaging members movable relative to each other wherein the relative movement creates a force opposing the relative movement, the engaging members operable to selectively engage the paint pad.

22. The apparatus of claim 17, which further includes a paint cover structured to be moveable relative to the paint pad to expose the paint pad.

23. The apparatus of claim 22, wherein the paint cover is rotatable relative to the paint pad and is actuated by a paint cover actuator.

24. An apparatus comprising:
a paint applicator device operable to be engaged with a paint pad and having a coupling protrusion; and
means for engaging the paint applicator device to the paint pad;
means for selectively moving the coupling protrusion relative to the paint pad; and
means for guarding an edge of the paint pad.

25. A method comprising:
moving a guard member to expose an edge of a paint pad; and
actuating an actuator member by moving the paint pad relative to a track;
selectively rotating the paint pad relative to a handle; and
disengaging a paint pad from the handle by moving two members coupled to the handle relative to each other.
